(19) United States
(12) Patent Application Publication
(10) Pub. No.: US 2005/0054817 A1
(43) Pub. Date: Mar. 10, 2005

(54) Use of modified linear low density polyethylene in shrink films and shrink films

(75) Inventors: Luis Fernando Cassinelli, Sao Paulo (BR); Alexandre Elias Leme Da Silva, Santo Andre (BR)

Correspondence Address: BIRCH STEWART KOLASCH & BIRCH, PO BOX 747, FALLS CHURCH, VA, 22040-0747, US

(73) Assignee: BRASKEM S.A.

(21) Appl. No.: 10/917,386

(22) Filed: Aug. 13, 2004

Related U.S. Application Data
(62) Division of application No. 10/149,296, filed on Sep. 13, 2002, now abandoned.

(30) Foreign Application Priority Data
Dec. 21, 1999 (BR) PI9906086-8

(51) Int. Cl. C08F 6/00

(52) U.S. Cl. 528/480

(57) ABSTRACT

A method for forming a shrink film comprised of a linear low density polyethylene (LLDPE) is provided comprising the steps of thermomechanically treating a linear low density polyethylene in the presence of a free radical generator to obtain a modified linear low density polyethylene; and extrusion-molding said modified linear low density polyethylene to obtain a shrink film.

### FIELD OF THE INVENTION

The present invention relates to the use of modified linear low-density polyethylene (LLDPE) in thermoshrinking films. More specifically, the present invention relates to the use of LLDPE in thermoshrinking films, either isolated or in blends with low density polyethylene (LDPE), where the amount of LLDPE is at least-50% w/w, the LLDPE being modified with a free radical generator.

### BACKGROUND OF THE INVENTION

Shrink wrapping has been largely employed as films on packing and to group a set of various volumes, so as to ease transport, improving aesthetics and protecting the packed products. A classical example of the use of said packing is the replacement of the soft drinks high density polyethylene (HDPE) rails by thermoshrinking films. Basically the process comprises packing the product and submitting it to heating (usually in oven or with the aid of a hot air pistol), whereby the film dimensions are reduced, so as to render the packing tight and suitable to its end use.

Films directed to such end use are made by extrusion of blown films, a molten tube being extruded usually upwards using drawing rolls placed of from 2 to 10 meters from the die. Upon air injection through the interior of the tube, a bubble is formed; the injected air expands the bubble diameter between 1.5 to 5 times the original diameter, causing the film to be molecularly oriented in the cross direction, while at the same time the film is molecularly oriented in the machine direction by using a higher speed of the drawing rolls relative to the extrusion speed.

The more widely used product for this kind of packing is high pressure polyethylene (LDPE). The LDPE structure contains a large amount of long chain branches; during the quick cooling step of the film the mobility of such chains is low, preventing relaxation, ensuing concentration of internal stress between chains during the formation of the film. Such stress is relaxed when the film is exposed to high temperatures, resulting to film shrinkage.

In spite of a significant production volume, products such as LLDPE are not suitable for use in shrink films since their chains are mainly linear, which means easier relaxation. This causes a limitation in the cross direction, in which this kind of product shows no contraction at all, with the occurrence of even an increase in the original dimensions, this rendering impracticable the desired end use.

Normally, in order to improve mechanical properties as well as sealability, low levels of LLDPE are employed in blends with LDPE in the described use, however the contents in LLDPE are kept around 40%, since beyond this limit the use is prevented by the reduction in shrinkage.

The advantages of LLDPE relative to LDPE are multiple: mechanical properties such as tensile strength, elongation at break and puncture resistance, besides the well-known sealability advantage.

Another advantageous feature of LLDPE is the improved drawdown ability.

On the contrary, in LDPE, the presence of highly branched chains is responsible for the adequate bubble stability formed in the extrusion of these products, but may restrict the ability of quick deformation of the melt, so that the manufacture of thin films may be impaired.

That is why the combined use of these two resins is very common as blends directed to the use of films aiming at obtaining a product having the above-mentioned balanced properties.

The patent literature teaches various uses of polyethylene films.

U.S. Pat. No, 4,460,750 teaches a process for the thermomechanical treatment of LLDPE copolymers, in the melt, in the presence of organic peroxides. This patent teaches that the peroxide treatment at temperatures lower than 220° C. improves the LLDPE transparency. This patent is directed to the improvement of transparency and processability of films, and is not concerned with the preparation of a shrink film.

Aiming at improving the polymer melt strength, U.S. Pat. No. 4,578,431 teaches a process for treating an ethylene copolymer or a high-density ethylene homopolymer prepared in the melt at a temperature between 230° C. and 340° C. in the presence of an organic peroxide. The preparation of shrink films is not mentioned.

U.S. Pat. No. 4,597,920 describes a shrink film having high optical clearness, good shrink properties and good mechanical properties that is obtained by the biaxial stretching of a polyethylene film containing at least one α-olefin having mandatory of between 8 and 18 carbon atoms, and which has not been submitted to crosslinking. This use is directed to a bioriented film to be used in shrink films. Contrary to this patent, in the present application the shrink film is obtained through the process of film extrusion itself, without the need to submit the film to a biaxial stretching.

EP patent 299,750 B1 discloses a mono-or biaxially stretched film mainly made up of a polyethylene and able to be made into a thinner film than is normally possible with the well-known kinds of those films. In spite of the fact that the film is extremely thin, it has excellent impact strength, stiffness, tensile strength and tear strength. In this patent, the peroxide addition is made exclusively on the mixture of LLDPE and LDPE while in the present application the peroxide addition is preferably made on the LLDPE and optionally the free radical generator may be directly added to the LLDPE and LDPE blend or yet it may be added directly to the film extrusion. Further, the process described in this patent occurs in two stages: in a first stage, the composition is extruded into a bubble so as to obtain a non stretched film, or only stretched as a consequence of the normal efforts caused by the extrusion. In a second step, the film suffers a monoaxial or biaxial stretch so as to increase the mechanical strength and improve the tear strength. In the present application there is no such second stretching step. The objectives of the said EP patent are directed to packing bags, while the present application is directed to shrink films.

EP publication 404,368 A2 teaches a composition of a film for packing articles by shrinking, the composition comprising a blend of 50 to 95 weight % of a LLDPE containing a comonomer having of from 3 to 10 carbon atoms and of 50 to 5 weight % of a LDPE obtained in high pressure reactors. This publication does not mention the use of a free radical generator for modifying the LLDPE.

U.S. Pat. No. 5,756,203 teaches the increase in LLDPE melt strength by the addition of low peroxide levels. Those low peroxide levels cause low crosslinking levels. This allows that LLDPE is turn into film under processing conditions close to those used for high density, high molecular polyethylene and conveys to the film a higher impact strength. This patent does not consider blends and aims at the increase in melt strength, without considering shrink films.

Therefore, the state-of-the-art references, taken alone or in combination, do not disclose nor suggest the matter described and claimed in the present application.

Thus, the technique still seeks uses for LLDPE, alone or in blends with LDPE, in amounts of at least 50% w/w, modified by free radical generator, in shrink films, as is described and claimed in the present application.

### SUMMARY OF THE INVENTION

The present invention relates to the use of LLDPE in shrink films, isolated or in blends with LDPE where the amount of LLDPE in the blend is at least 50% w/w, the resins being modified with free radical generator.

The use of LLDPE isolated or in blends in shrink films according to the invention comprises:
Submitting the LLDPE to a thermomechanical treatment in the presence of a free radical generator, so as to obtain the modified LLDPE;
Extrusion molding the modified LLDPE obtained, so as to produce a shrink film;
Applying the shrink film so produced on the volumes to be contained by the film, and heating to obtain the ready shrink film.

The use of the present invention makes possible to produce films having at least 50% w/w of LLDPE in their composition, such films meeting with the shrinkage requirements of the use of shrink films associated to the already mentioned advantages of LLDPE relative to LDPE.

Thus, the present invention provides a use of LLDPE modified by a free radical generator, the LLDPE being used in shrink films, isolated or in blends with LDPE where the amount of LLDPE is at least 50% w/w of the blend.

The present invention provides further shrink films obtained from the modified LLDPE, isolated or in blends with LDPE, where the amount of LLDPE in the blend is at least 50% w/w.

The present invention provides further shrink films having superior mechanical and sealing characteristics, such as puncture and tensile strength and elongation at break.

The present invention provides further shrink films of reduced thickness.

### DETAILED DESCRIPTION OF THE PREFERRED EMBODIMENTS

The use according to the invention is based on LLDPE, that is a copolymer of ethylene and one or more α-olefin of from 3 to 12 carbon atoms, linear or branched, containing around 4 and 20% w/w of this (these) α-olefin (s), isolated or combined in any amount, that is (are) preferably selected among propylene, 1-butene, 4-methyl-l-pentene, 1-hexene and 1-octene, having density (measured according to ASTM Method D-1501) between 0.900 and 0.940, preferably between 0.915 and 0.925, and melt flow index (measured according to ASTM Method D-1238 condition 190° C./2.16 kg) between 0.3 to 40 g/10 min, preferably between 1 and 10 g/10 min, produced by low pressure polymerisation in the presence of a transition metal/aluminium alkyl catalyst.

The modified LLDPE to be applied in the use of the invention is obtained by reaction with a free radical generator. This free radical generator is not critical and may be for example heat, high frequency radiation, organic peroxides, azo compounds, organic peracids, compounds having at least two quaternary vicinal carbon atoms, isolated or combined in any amount.

For the purposes of the present invention the organic peroxides include the typical compounds: benzoyl peroxide; dichlorobenzoyl peroxide; dicumyl peroxide; di-t-butyl peroxide; 2,5-dimethyl 3-hexyne 2,5-diperoxybenzoate; 1,3-di (t-butyl-peroxy) diisopropyl benzene; lauroyl peroxide; t-butyl peracetate; 2,5-dimetyl-3-hexyne 2,5-diperoxy-t-butylate; 2,5-dimetyl hexane 2,5-diperoxy-t-butylate and t-butyl perbenzoate. Typical azo compounds include aza-isobutyronitrile and dimethyl-aza-diisobutyrate, which show insignificant decomposition level at temperatures below 100° C. and half life period lower than 1 minute at the temperatures usually employed for processing LLDPE (120-280° C.).

The content of free radical generator varies of from 0.005 to 1-% w/w based on the weight of LLDPE. Preferably the content of free radical generator varies between 0.01 to 0.1% w/w based on the weight of LLDPE. Preferably the organic peroxide used as free radical generator in the present invention is selected between 1,3-di (t-butyl peroxi) diisopropyl benzene, 2,5-dimethyl hexane 2,5-diperoxi-t-butylate and dicumyl peroxide.

The peroxide-modified LLDPE is prepared through a thermomechanical treatment, which comprises homogeneously mixing the polyethylene with a free radical generator. In the present application the peroxide addition is preferably effected on the LLDPE and optionally the free radical generator may be directly added to the blend of LLDPE and LDPE or still directly to the film extrusion. The mixture with the free radical generator occurs at a temperature where the decomposition of the free radical generator is negligible. After this first mixture the product is made to melt in an extruder and the temperature is raised to the range between 120-280° C., preferably in the range 180-250° C., where the half life period of the free radical generator is generally rather low, whereby the initial product is modified.

Alternatively, the initial mixture step may be effected in the extruder itself.

The modification introduced in the LLDPE may be evidenced and quantified by measuring the reduction in the melt flow index.

As relates to the modified product, besides meeting the requisites for complying with the needs of the use in shrink film, some other advantages mentioned before were confirmed, such as the improvement in the processability of LLDPE caused by an increase in its pseudoplasticity that makes possible to process it in equipment projected for the processing of LDPE as described in U.S. Pat. No. 4,460,750; as well as the increase in melt strength for the LLDPE as described in U.S. Pat. No. 4,578,431.

LDPE is a commercial product obtained by polymerising ethylene under high pressure and temperature in the presence of free-radical initiators. Density is around 0.912 and 0.935. Number and weight molecular weight ratios are typically in the range of 20 to 50.

According to the use of the invention in shrink films, the modified LLDPE may be used isolated or in an amount of at least 50% w/w in blends with LDPE.

The desired balance of properties for each application, besides economical considerations determines the ideal amount of LLDPE.

The properties of the shrink film obtained after the thermal treatment of LLDPE isolated or blended are a function of the amount of LLDPE in the blend. Thus, features of better sealability, puncture resistance and tensile strength and elongation at break linked to LLDPE will be conveyed to the end product, the shrink film.

As a consequence of the higher strength caused by LLDPE, it will be possible to make a thinner, shrink film having the same mechanical properties, this leading to a significant cost reduction.

The Examples below should not be construed as limiting the invention.

### EXAMPLES

A commercial LLDPE of specific weight 0.918 was mixed with different contents of the 1,3-di (t-butyl peroxi) diisopropyl benzene peroxide. Initially the LLDPE and the peroxide were homogenised at ambient temperature through physical blending, the blend being then palletised in a palletising extruder at a temperature of 220° C. After the pelletisation the melt index (MI) of the product aiming at evaluating the effectiveness of the peroxide incorporation was determined.

TABLE 1 below evidences the modification of the molecular structure of the LLDPE polymer through reaction with the peroxide.

TABLE 1

| Peroxide, ppm | MI (g/10 min) |
|---|---|
| 0 | 2.0 |
| 320 | 0.91 |
| 400 | 0.67 |
| 401 | 0.53 |

In order to check the shrinkage behaviour of the films, films from the products having the peroxide incorporated were processed after pelletisation. Film extrusion was only run for the samples having 320 and 480-ppm peroxide identified respectively as 2A and 2B in TABLE 2 below.

As comparative standard a mixture usually used for the shrink application was employed, said mixture being a blend of 80% w/w of LDPE having MI 0.28 with 20% w/w LLDPE having MI 0.55, said mixture being identified as 2C in TABLE 2; while to check the advantages of the invention a LLDPE identified as 2D in TABLE 2 was used, which is not modified with a free radical generator and having MI similar to the final MI of sample 2B. LLDPE-rich samples 2A, 2B and 2D, were processed with 20% w/w LDPE.

TABLE 2 below illustrates the shrinkage test results in the machine direction (MD) and in the cross direction (CD) for the standard, for the non-modified LLDPE and for LLDPE prepared according to the present invention. Figures measured for tensile strength and elongation at break are also presented.

In order to determine the shrinkage percentage in the MD and CD directions, five circular samples of 50 mm diameter were submitted to a temperature of 150° C. during one minute in a Hanatek Film “Free Shrink” tester, and the shrinkage in each direction was determined. In order to determine the values measured for tensile strength and elongation at break the method described in ASTM Method D-882 was used.

TABLE 2

| | Shrinkage | | Tensile Strength | | Elongation at | |
|---|---|---|---|---|---|---|
| | (%) | | (MPa) | | Break (%) | |
| SAMPLE | MD | CD | MD | CD | MD | CD |
| 2A | 66 | 9 | nd² | nd² | nd² | nd² |
| 2B | 70 | 18 | 33 | 30 | 1224 | 1545 |
| 2C | 77 | 25 | 28 | 29 | 492 | 1239 |
| 2D | 76 | 0¹ | 35 | 36 | 1178 | 1524 |

¹the dimension increased
²Non determined

The advantages found for the shrinking in the cross direction for peroxide-modified LLDPE (2A and 2B) relative to the non-modified LLDPE are an evidence of the excellence of the method for increasing the shrinking in the cross direction, this being the main drawback for the use of LLDPE in shrink films. It was also found that the increase in shrinkage caused by the modification with the free radical generator increases with the increase in concentration of the free radical generator, this being seen from Examples 2A and 2B.

In spite of the difference found between the figure for shrinkage of the peroxide-modified LLDPE film (2A and 2B) and the control (2C), practical tests made with end consumers demonstrated that the obtained shrinkage level makes already possible to use the inventive modified LLDPE in shrink films.

The mechanical properties of the films obtained in examples 2B and 2D were shown to be very similar, which indicates that no significant loss of these properties was verified as a result of the modification of LLDPE with the free radical generator. The better performance of the free radical generator-modified LLDPE (2B) relative to the LDPE (2C) was also evidenced.

The example with the non-modified LLDPE (2D) shows results that are different from those disclosed in EP Patent 404.368 A2 since when using the non-modified LLDPE its dimensions were increased.

A commercial LLDPE of specific weight 0.918 was blended to LDPE in the amount of 20% w/w LDPE and this blend was further homogenised and 320 ppm of 1,3-di (t-butyl peroxi) diisopropyl benzene peroxide were added at ambient temperature by physical mixing (blending). The obtained blend was palletised in a palletising extruder at a temperature of 220° C. After palletising, a film was processed, which is identified as 3A in TABLE 3 below. The film was then submitted to the shrinkage test listed in TABLE 3.

TABLE 3

| Identification | Shrinkage (MD) (%) | Shrinkage (CD) (%) |
|---|---|---|
| 3A | 67 | 11 |

1. A method for forming a shrink film comprised of a linear low density polyethylene (LLDPE) comprising the steps of:
thermomechanically treating a linear low density polyethylene in the presence of a free radical generator to obtain a modified linear low density polyethylene; and
extrusion-molding said modified linear low density polyethylene to obtain a shrink film.

2. The method of claim 1, wherein said LLDPE which is submitted to said thermomechanical treatment comprises a blend with up to 50% w/w LDPE.

3. The method of claim 1, wherein said modified LLDPE is blended with LLDPE prior to said extrusion-molding step.

4. The method of claim 3, wherein said blend comprises at least 50% w/w LLDPE.

5. The method of claim 1, wherein said LLDPE is a copolymer of ethylene with one or more linear or branched α-olefins having from 3 to 12 carbon atoms, containing between 4 and 20% w/w of said α-olefins, having density between 0.900 and 0.940 g/cm³, and a melt index between 0.3 and 40 g/10 min, obtained by low pressure polymerization in the presence of a transition metal/aluminum alkyl catalyst.

6. The method of claim 5, wherein said α-olefins are selected from the group consisting of propylene, 1-butene, 4-methyl-1-pentene, 1-hexene and 1-octene.

7. The method of claim 5, wherein said LLDPE has a density within the range of 0.915 to 0.925 g/cm³, and a melt index within the range of 1 and 10 g/10 min.

8. The method of claim 1, wherein said free radical generator is selected from the group consisting of heat, high-frequency radiation, organic peroxides, azo compounds, organic peracids, compounds having at least two quaternary vicinal carbons, or mixtures thereof.

9. The method of claim 8, wherein said organic peroxide is selected from the group consisting of benzoyl peroxide, dichlorobenzoyl peroxide, dicumyl peroxide, di-t-butyl peroxide, 2,5-dimethyl 3-hexyne 2,5-diperoxybenzoate, 1,3-di(t-butyl peroxy)diisopropyl benzene, lauroyl peroxide, t-butyl peracetate, 2,5-dimethyl-3-hexyne 2,5-diperoxy-t-butylate, 2,5-dimethyl hexane 2,5-diperoxy-t-butylate, and t-butyl perbenzoate.

10. The method of claim 9, wherein said peroxide is selected from the group consisting of 1,3-di (t-butyl peroxy) diisopropyl benzene, 2,5-dimethyl hexane 2,5-diperoxy-t-butylate and dicumyl peroxide.

11. The method of claim 9, wherein said azo compound comprises aza-isobutyro nitrile and dimethyl aza-diisobutyrate.

12. The method of claim 9, wherein the concentration of said free radical generator is between 0.005 to 1% w/w based on the weight of LLDPE.

13. The method of claim 12, wherein the concentration of said free radical generator is between 0.01 and 0.1% w/w based on the weight of LLDPE.

14. The method of claim 1, wherein said thermomechanical treatment comprises homogeneously blending said LLDPE with said free radical generator at a temperature where decomposition of said free radical generator is minimal, melting said blend in a thermomechanical mixer, and increasing the temperature to a temperature in the range of 120-280° C. to decompose said free radical compound and modify said LLDPE.

15. The method of claim 14, wherein said thermomechanical treatment is conducted in an extruder at a temperature of from 180-250° C.

16. The method of claim 1, further including the step of applying said shrink film to a substrate to be covered by said film, and heating said film to shrink said film on said substrate.

17. The method of claim 16, wherein said shrink film is applied to multiple substrates to form a single packing of said substrates upon heat shrinking of said film.
